(19) United States
(12) Patent Application Publication
(10) Pub. No.: US 2002/0098802 A1
(43) Pub. Date: Jul. 25, 2002

(54) Mobile satellite communications systems, gateways and methods supporting multiple air interface standards

(76) Inventor: Peter D. Karabinis, Cary, NC (US)

Correspondence Address: Robert M. Meeks, Myers Bigel Sibley & Sajovec, P.A., Post Office Box 37428, Raleigh, NC, 27627, US

(21) Appl. No.: 09/735,383

(22) Filed: Dec. 12, 2000

(51) Int. Cl. H04B 7/185

(52) U.S. Cl. 455/13.1; 455/428; 455/427; 455/12.1

(57) ABSTRACT

A mobile satellite communications system includes a ground station including a first air interface circuit operative to communicate with a satellite according to a first air interface standard and a second air interface circuit operative to communicate with the satellite according to a second air interface standard. The first and second air interface circuit may be included in a gateway that further comprises a telecommunications switch operative to transfer information between the first and second air interface circuits and/or between respective ones of the first and second air interface circuits and an external communications system. For example, the first and second air interface standard may comprise respective first and second time division multiple access (TDMA) air interface standards, such as TDMA standards having different carrier frequency bandwidths and/or slot structures. In other embodiments, the first and second air interface standards may comprise a TDMA air interface standard and a code division multiple access (CDMA) air interface standard, respectively. The first air interface standard may be a “native” standard used by the mobile satellite communications system, and the second air interface standard may be an air interface standard native to a second mobile satellite communications system, for example, a neighboring system having users that may intermittently travel into the coverage area of the first mobile satellite communications system. Related methods are also discussed.

### BACKGROUND OF THE INVENTION

The present invention relates to communications systems and methods, and more particularly, to mobile satellite communications systems and methods.

Mobile satellite communications systems are increasingly being used to provide communications services, especially in parts of the world previously underserved with communications services and having topography and/or demographics that make installation of terrestrial landline or cellular infrastructure impractical or economically unjustified. Typically, these systems provide voice and other communications services to mobile terminals, such as handheld or vehicle-mounted radiotelephones, as well as to fixed terminals located within their service areas. For example, the Asia Cellular Satellite System (ACeS) has been deployed to provide telephone and other communications services, such as fax and data services, in Asia and the Indian Subcontinent, as described at http://www.acesy.com. Another system, referred to as Thuraya, is currently being deployed to provide similar services to parts of the Indian Subcontinent, the Middle East, Central Asia, North and Central Africa, and Europe, as described at http://www.thuraya.com. FIG. 1 conceptually illustrates a conventional mobile satellite communications system 100, such as the ACeS system and the Thuraya system. Terminals 10 located in a coverage area defined by a plurality of spot beams 12 communicate with a ground station 30 via a satellite 20 that acts as a radio frequency (RF) relay or “bent pipe.” In particular, the ground station 30 transmits information intended for a terminal 10 on a forward channel comprising an uplink channel 26 of a feeder link 25 from the ground station 30 to the satellite 20, and the satellite 20 retransmits the information received on the uplink channel 26 to the terminal 10 on a downlink channel 16 of a mobile link 15. For example, in the aforementioned ACeS system, the uplink channel 26 is a time division multiple access (TDMA) channel, i.e., set of time slots, defined on a 200 KHz frequency band of the so-called C-band. The downlink channel 16 is a corresponding TDMA channel defined on a corresponding TDMA channel on a 200 KHz frequency band of the so-called L-band, wherein transmission on the 200 KHz L-band downlink uses the same slot structure as the 200 KHz C-Band uplink such that the downlink channel 15 represents a C-band to L-band shifted version of the uplink channel 26. A similar structure using 50 KHz frequency subbands is used to define a return link comprising an L-band uplink channel 17 of the mobile link 15 between the mobile terminal 10 and the satellite 20 and a C-band downlink channel 27 of the feeder link 25 between the satellite 20 and the ground station 30. The ACeS air interface conforms to a standard referred to as the Geostationary Mobile Satellite Standard (GMSS) and is described in Asia Cellular Satellite System SAIS: Multiplexing and Multiple Access on the Radio Path (SAIS 5.02), published by Lockheed Martin Corporation, PT Asia Cellular Satellite, and Ericsson Mobile Communications AB (1998). The Thuraya air interface conforms to a proprietary standard of the Geomobile (GEM) satellite system produced by Boeing Satellite Systems (formerly Hughes Space and Communications International, Inc.).

The ground station 30 includes an antenna 32 and a gateway 34. The antenna 32 sends and receives RF signals to and from the satellite 20 according to an air interface as discussed above. The gateway 34 serves as an interface between the RF channels defined by the mobile satellite communications system 100 and one or more other communications systems, such as a public switched telephone network (PSTN) 40 or a public land mobile network (PLMN) 50. For example, the gateway 34 may include a mobile switching center (MSC) that routes calls between telephones served by the PSTN 40 and terminals served by the mobile satellite communications system 100.

The mobile satellite communications systems currently deployed and/or under development have a variety of different characteristics arising from, among other things, different service goals, different equipment providers, and the like. Accordingly, users of terminals designed to work with one mobile satellite communications systems may be unable to use these same terminals when located in the coverage area of another mobile satellite communications systems.

### SUMMARY OF THE INVENTION

According to embodiments of the present invention, a gateway for a mobile satellite communications system includes a first air interface circuit operative to communicate with a satellite according to a first air interface standard and a second air interface circuit operative to communicate with the satellite according to a second air interface standard. The gateway further comprises a telecommunications switch operative to transfer information between the first and second air interface circuits and/or between respective ones of the first and second air interface circuits and an external communications system. For example, the first and second air interface standards may comprise respective first and second time division multiple access (TDMA) air interface standards, such as TDMA standards having different carrier frequency bandwidths and/or slot structures. In other embodiments, the first and second air interface standards may comprise a TDMA air interface standard and a code division multiple access (CDMA) air interface standard, respectively. The first air interface standard may be a “native” standard used by the mobile satellite communications system, and the second air interface standard may be an air interface standard that is native to a second mobile satellite communications system, for example, a neighboring system having users that may intermittently travel into the coverage area of the first mobile satellite communications system.

In some embodiments of the present invention, the first air interface circuit comprises a first channel unit operative to communicate with the satellite on first channels defined according to the first air interface standard and to convey information between the telecommunications switch and the first channels and a first channel unit controller operative to control the first channel unit. The second air interface circuit comprises a second channel unit operative to communicate with the satellite on second channels defined according to the second air interface standard and to convey information between the telecommunications switch and the second channels, and a second channel unit controller operative to control the second channel unit. According to other embodiments of the present invention, a mobile satellite communications system comprises at least one satellite operative to communicate with mobile terminals. The system further comprises a ground station including a first air interface circuit operative to communicate with the satellite according to a first air interface standard and a second air interface circuit operative to communicate with the satellite according to a second air interface standard. The first and second air interface circuits may be included in a gateway that further comprises a telecommunications switch operative to transfer information between the first and second air interface circuits and/or between respective ones of the first and second air interface circuits and an external communications system.

According to method embodiments of the present invention, a mobile satellite communications system comprising a satellite operative to communicate with mobile terminals over mobile links and to communicate with a ground station over a feeder link is operated by communicating between the satellite and the ground station over the feeder link using first and second air interface standards. For example, first information associated with a first mobile terminal may be communicated over the feeder link according to the first air interface standard, and second information associated with a second mobile terminal may be communicated over the feeder link according to the second air interface standard.

### BRIEF DESCRIPTION OF THE DRAWINGS

FIG. 1 is a schematic diagram illustrating a mobile satellite communications system according to the prior art.

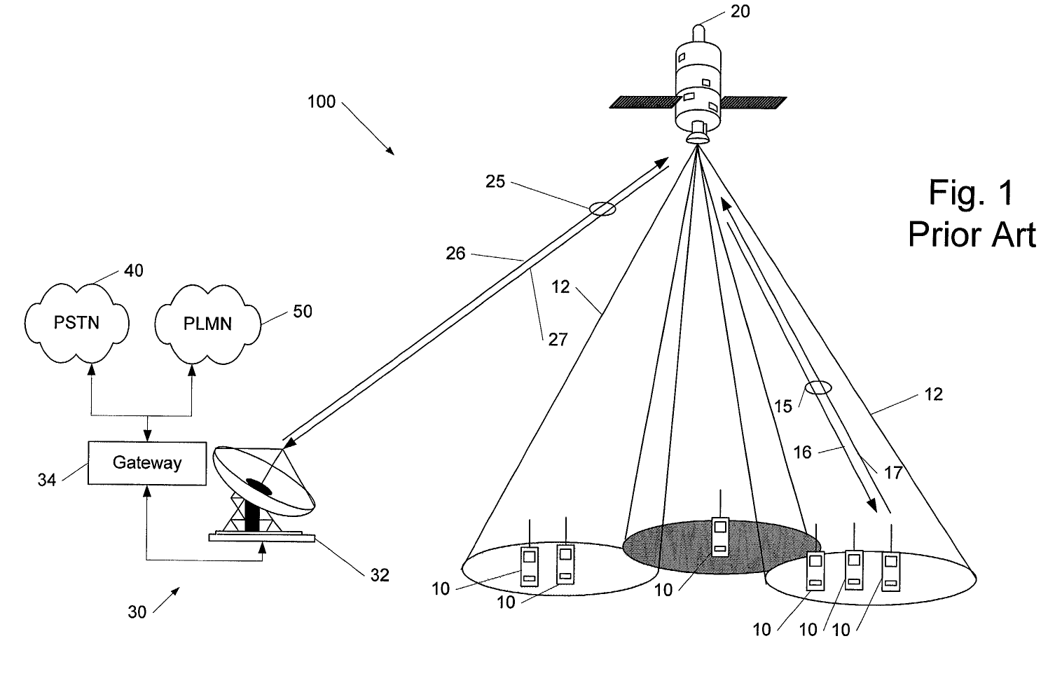

FIG. 2 is a schematic diagram illustrating a mobile satellite communications system according to embodiments of the present invention.

FIG. 3 is a schematic diagram illustrating a ground station for a mobile satellite communications system according to embodiments of the present invention.

FIG. 4 illustrates a dual air interface capable mobile satellite communications system according to embodiments of the present invention.

FIG. 5 illustrates a dual TDMA air interface capable mobile satellite communications system according to other embodiments of the present invention.

FIG. 6 illustrates a ground station for a dual TDMA air interface capable mobile satellite communications system according to embodiments of the present invention.

FIG. 7 is a chart illustrating exemplary frequency allocations for a dual TDMA air interface capable mobile satellite communications system according to embodiments of the present invention.

FIG. 8 is a schematic diagram illustrating a dual TDMA/CDMA air interface capable mobile satellite communications system according to still other embodiments of the present invention.

FIG. 9 is a chart illustrating exemplary frequency allocations for a dual TDMA/CDMA air interface capable mobile satellite communications system according to embodiments of the present invention.

### DETAILED DESCRIPTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. In the drawings, like numbers refer to like elements throughout.

The description herein refers to apparatus and methods of a mobile satellite communications system. It will be understood that, as used herein, a “mobile satellite communications system” includes systems that include at least one satellite designed to communicate with both mobile and fixed terminals. “Terminals” as described herein include both mobile and fixed wireless communications terminals.

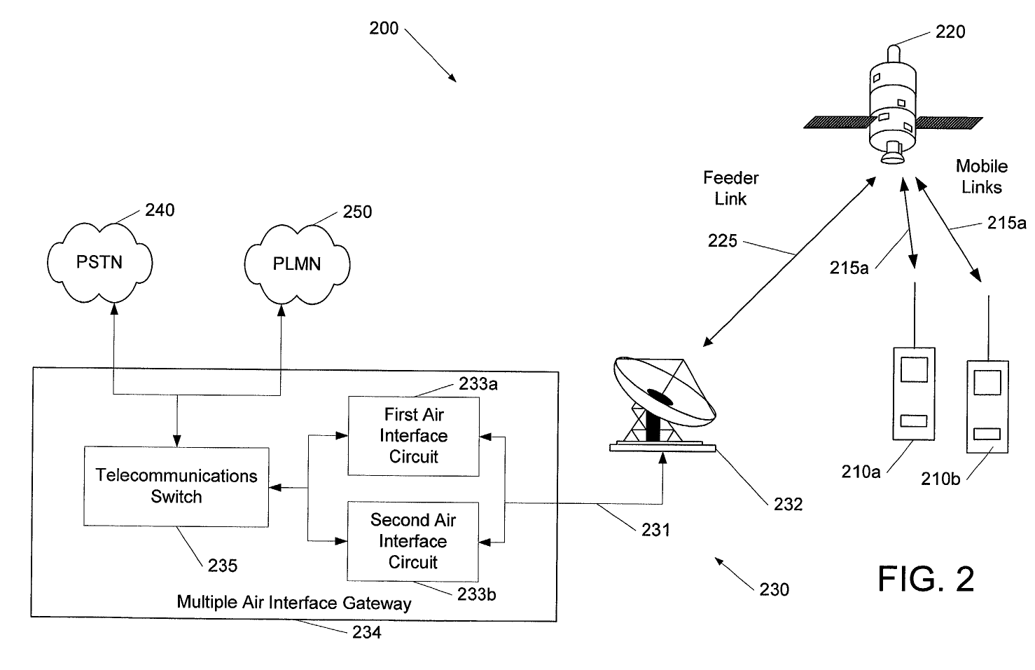

FIG. 2 illustrates a mobile satellite communications system 200 and methods for communicating with terminals 210a, 210b according to embodiments of the present invention. The mobile satellite communications system 200 includes a satellite 220 operative to communicate with the terminals 210a, 210b over respective mobile links 215a, 215b. Information is conveyed between a ground station 230 of the system 200 and the terminals 210a, 210b via the satellite 220 on a feeder link 225. The ground station 230 includes an antenna 232 that sends and receives radio frequency (RF) signals to and from the satellite 220. The RF signals are conveyed between the antenna 232 and a multiple air interface gateway 234 via an RF signal path 231.

The multiple air interface gateway 234 includes a first air interface circuit 233a that is operative to communicate with the satellite 220 over the feeder link 225 according to a first air interface standard, i.e., to communicate with the satellite 220 via channels defined according to the first air interface standard. The multiple air interface gateway 234 also includes a second air interface circuit 233b operative to communicate with the satellite 220 over the feeder link 225 according to a second, different air interface standard. The multiple air interface gateway 234 also includes a telecommunications switch 235 operative to transfer information between the first and second air interface circuits 233a, 233b and between respective ones of the first and second air interface circuits 233a, 233b and one or more external communications systems, such as a PSTN 240 or a PLMN 250.

It will be appreciated that system 200 may have a variety of different configurations. For example, the system 200 may include more that one satellite 200 and more than one ground station 230. Rather than a single antenna 232, the ground station 230 may employ an array of antennas. The antenna 232 and multiple air interface gateway 234 may be physically proximate or separated. Components of the gateway 234 may be co-located at an integrated facility, or may be distributed across a geographical area. The multiple air interface gateway 234 may comprise conventionally used telecommunication components. For example, the first and second air interface circuits 233a, 233b may include conventional RF transmitters and receivers and associated control components. Although shown as separate blocks in FIG. 2, the first and second air interface circuit 233a, 233b may be integrated into a common assembly, and may share common components. For example, the first and second air interface circuit 233a, 233b may share such components as power supplies and data processing devices such as digital signal processors (DSPs). RF signal processing components may also be shared between the first and second air interface circuits 233a, 233b. For example, common RF signal processing apparatus may be shared between the first and second air interface circuits 233a, 233b. The telecommunications switch 235 may include components conventionally employed in mobile switching centers (MSC's) or other voice and data communications infrastructure.

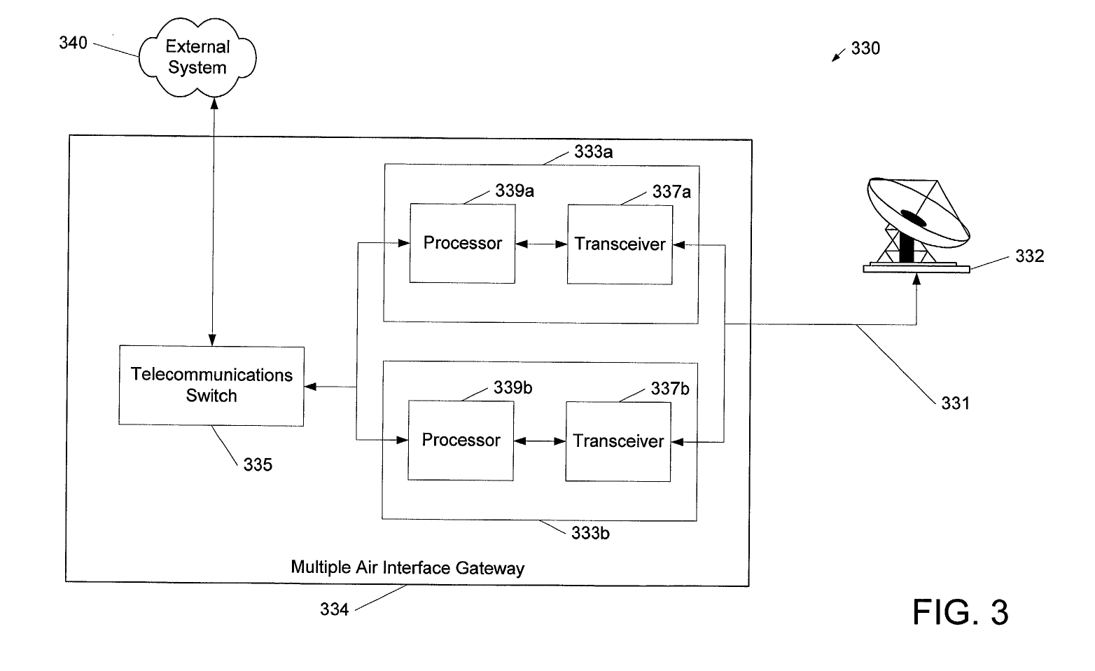

For example, as illustrated in FIG. 3, a ground station 330 according to some embodiments of the present invention includes an antenna 332 that sends and receives RF signals. The ground station 330 further comprises a multiple air interface gateway 334 including first and second air interface circuits 333a, 333b coupled to the antenna 332 by an RF signal path 331. As shown, the first and second air interface circuits 333a, 333b include respective combinations of an RF transceiver 337a, 337b and a processor 339a, 339b. The processors 339a, 339b communicate information between the RF transceivers 337a, 337b and a telecommunications switch 335. The telecommunications switch 335 serves as an interface between the first and second air interface circuit 333a, 333b and between respective ones of the first and second air interface circuit 333a, 333b and an external communications system 340. In particular, the processors 339a, 339b control transmit and receive operations of the RF transceivers 337a, 337b, as well as data routing and other control operations needed to transfer information between RF channels supported by the transceivers 337a, 337b and the telecommunications switch 335.

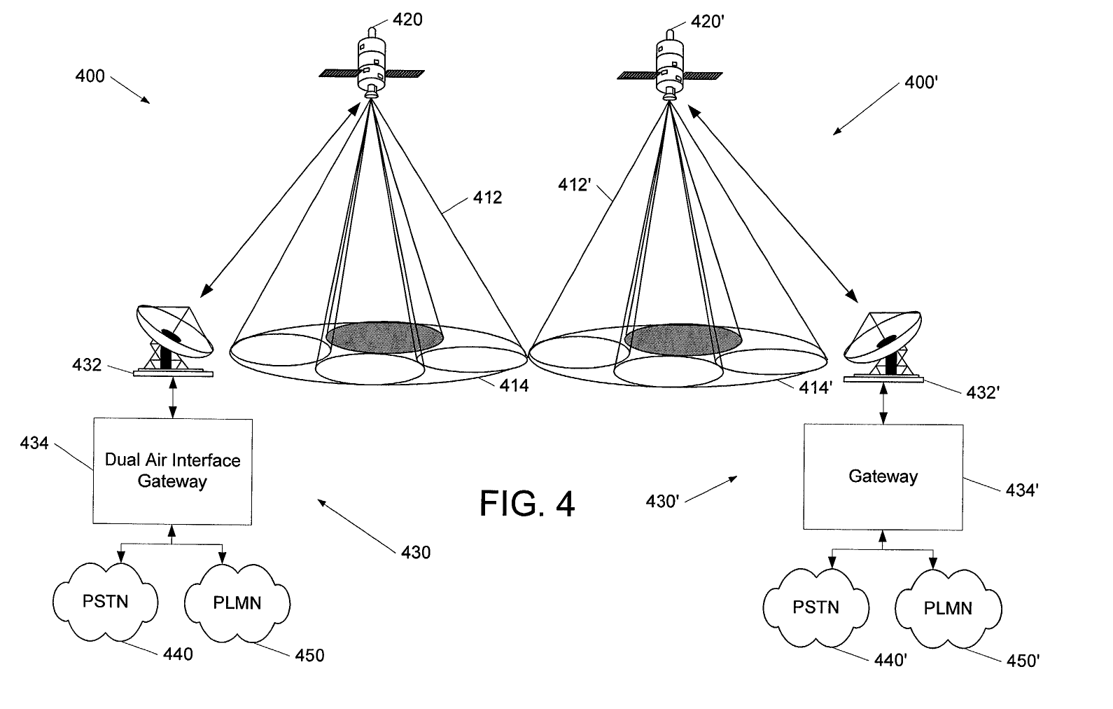

FIG. 4 illustrates an advantageous use of multiple air interface capabilities according to embodiments of the present invention. A first mobile satellite communications system 400 communicates with terminals located in a first coverage area 414 defined by spot beams 412. The first mobile satellite communications system 400 includes a ground station 430 including an antenna 432 and a dual air interface gateway 434 that is operative to communicate with the satellite 420 according to first and second air interface standards, and that is also operative to provide an interface between RF channels supported under the first and second air interface standards and between RF channels and external communications networks, such as a PSTN 440 and a PLMN 450.

A second mobile satellite communications system 400′ communicates with terminals located in a second, neighboring coverage area 414′ defined by spot beams 412′. The second mobile satellite communications system 400′ includes a ground station 430′ including an antenna 432′ and a gateway 434′ that is operative to communicate with the satellite 420′ according to the second air interface standard, and provides an interface to external communications networks, such as a PSTN 440′ and a PLMN 450′.

The present invention arises from a realization that it may be desirable to use terminals designed for use with one satellite communications system in another system as users of these terminals may travel between the coverage areas of the systems. Differences in the air interface standards supported by these systems, however, may prevent use of terminals designed for one of the mobile satellite communications systems with the other system. Terminals that can be used in either system may be undesirably costly and/or complex. In addition, such multi-mode terminals may not be economically attractive to users, as a user may only occasionally need to use his or her terminal outside of its “home” system, e.g., during the occasional business trip or vacation.

According to embodiments of the present invention, providing a gateway that supports multiple air interfaces may be a more effective and cost efficient solution than providing multi-mode terminals. Typically, mobile satellite communications systems have relatively few gateways, as the satellites used in mobile satellite communications systems are typically capable of supporting very large coverage areas. Accordingly, support of multiple air interfaces in a mobile satellite communications system can be achieved with changes in the system's ground infrastructure that are relatively minor and transparent to users.

With continuing reference to FIG. 4, because the respective ground stations 430, 430′ of the respective systems 400, 400′ may use a common frequency range to communicate between ground stations 430, 430′ and satellites 420, 420′ and a common frequency range to communicate between terminals and the satellites 420, 420′, a terminal designed for use in one system 400′ may be used in the other system 400 by providing the dual air interface gateway 434 that supports the air interface standard used in the neighboring system 400′ as well as the air interface standard native to the system 400. Thus, calls to and from a “non-native” terminal may be routed via the dual air interface gateway 434 to a telephone connected to the PSTN 440, to a cellular telephone using the PLMN or to a “native” mobile satellite terminal served by the mobile satellite communications system 400. It will be appreciated that the neighboring system 400′ may be provided with a complementary capability. Such dual operation may not require the modification of the satellites 420, 420,′ e.g., where the satellites merely act as frequency-shifting relays between mobile terminals and the ground stations 430, 430′.

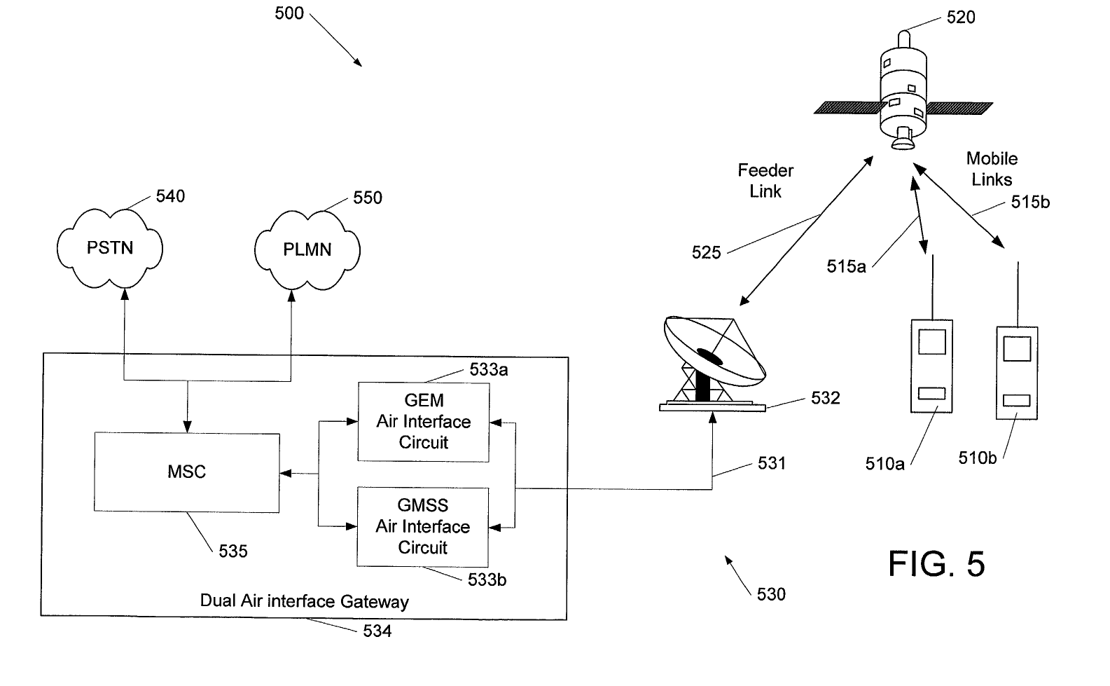

FIG. 5 illustrates a mobile communications system 500 having a dual air interface capability according to embodiments of the present invention. In particular, FIG. 5 illustrates a system architecture representing the proposed Thuraya mobile satellite communications system modified to provide service to a terminal 510b designed for use with the neighboring ACeS mobile satellite communications system.

The system 500 includes a satellite 520 operative to communicate with a Thuraya-compatible terminal 510a and the ACeS-compatible terminal 510b over respective mobile links 515a, 515b. The system 500 further includes a ground station 530 linked to the satellite 520 by a feeder link 525. The ground station 530 includes an antenna 532 and a dual air interface gateway 534. The dual air interface gateway 534 includes a GEM air interface 533a, e.g., a transceiver and associated control circuitry that operates in manner compatible with the GEM air interface specified for the Thuraya mobile satellite communications system, linked to the antenna 532 by an RF signal path 531. The GEM air interface standard is described in ETSI Technical Specification GMR-1 (to be officially released in the first quarter of 2001). The dual air interface gateway 534 also includes a GMSS air interface circuit 533b, e.g., a transceiver and associated control circuitry that operates in a manner compatible with the GMSS air interface standard utilized in the ACeS mobile satellite communications system, that is also linked to the antenna 532 by the RF signal path 531. The GMSS air interface standard is described in Asia Cellular Satellite System SAIS: Multiplexing and Multiple Access on the Radio Path (SAIS 5.02), published by Lockheed Martin Corporation, PT Asia Cellular Satellite, and Ericsson Mobile Communications AB (1998), which is incorporated herein by reference in its entirety. The GMSS air interface standard is also described in ETSI Technical Specification GMR-2 (to be officially released in the first quarter of 2001).

The dual air interface gateway 534 further includes a mobile switching center (MSC) 535 coupled to the GEM air interface circuit 533a and the GMSS air interface circuit 533b. The MSC 535 provides communications between the GEM air interface circuit 533a and the GMSS air interface circuit 533b and between respective ones of the GEM air interface circuit 533a and the GMSS air interface circuit 533b and one or more external networks, such as a PSTN 540 or a PLMN 550.

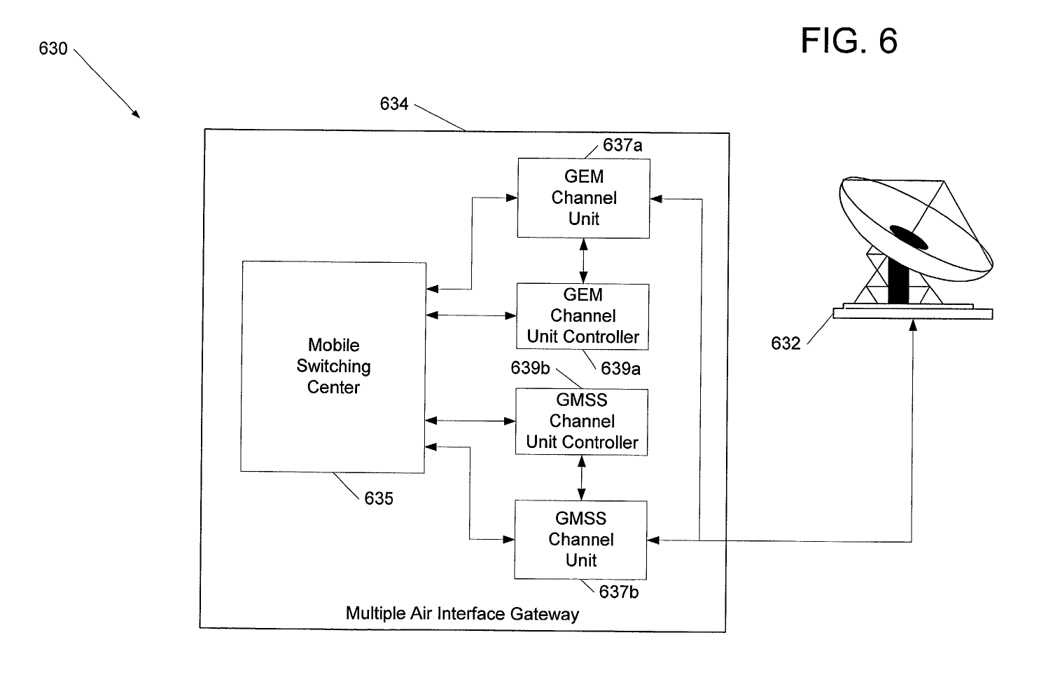

FIG. 6 illustrates an exemplary implementation of a ground station 630 for a mobile satellite communications system, such as the system 500 of FIG. 5. In particular, the station 630 includes a dual interface gateway 634 supporting both GEM and GMSS air interface standards. The gateway 634 includes a GEM channel unit 637 that is coupled between an MSC 635 and an antenna 632, along with a GEM channel unit controller 639a that controls operations of the GEM channel unit 637. The dual air interface gateway 634 further includes a GMSS channel unit 637b coupled between the MSC 635 and the antenna 632, and an associated GMSS channel unit controller 639b that controls operations of the GMSS channel unit 637a. Individual operations of channel units and channel unit controllers are known to those skilled in the art, and will not be discussed in further detail herein.

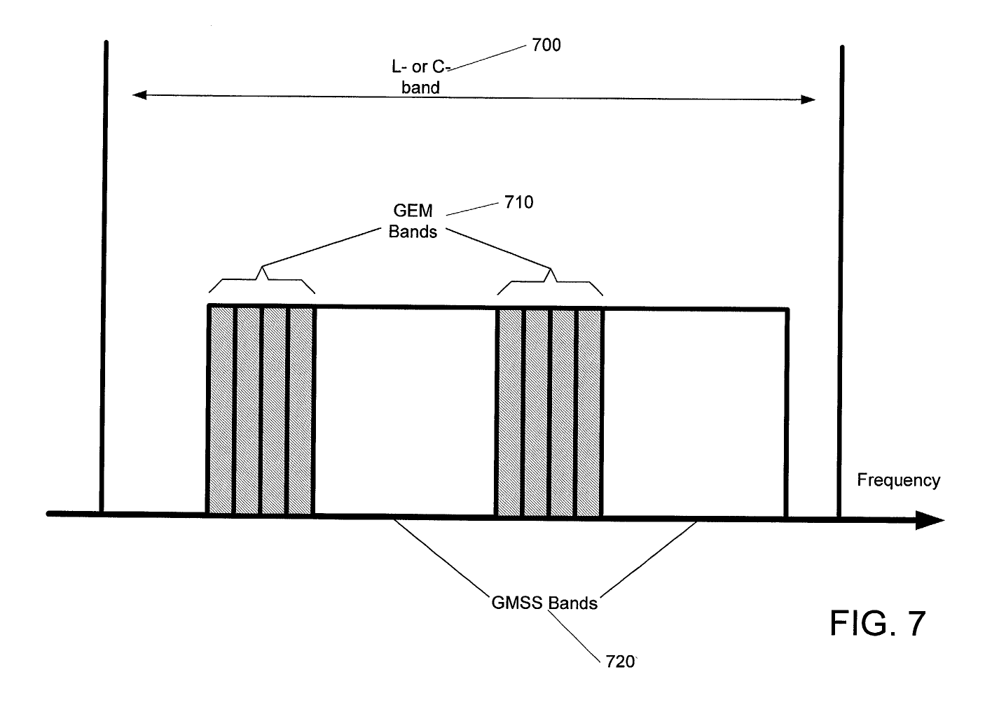

FIG. 7 provides an illustration of how the GEM air interface circuit 533a and the GMSS air interface circuit 533b of FIG. 5 may use common feeder link or mobile link frequency ranges to support both the GEM and GMSS air interface standards. In particular, within an L-band or C-band frequency range 700, a first plurality of frequency bands 710 may be allocated to a GEM air interface. A second plurality of frequency bands 720 may be allocated to a GMSS air interface.

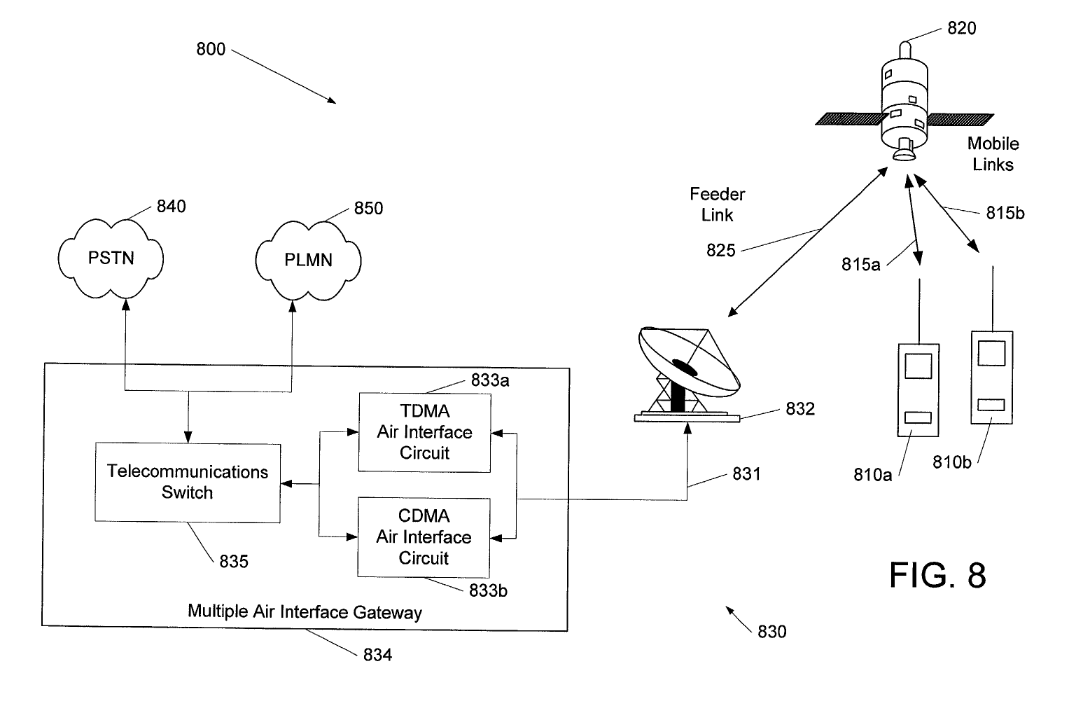

It will be appreciated that the present invention is also applicable to other combinations of air interface standards. For example, referring to FIG. 8, a mobile satellite communications system 800 according to some embodiments of the present invention includes a satellite 820 that is operative to communicate with first and second terminals 810a, 810b according to respective TDMA and CDMA air interface standards. For example, the TDMA air interface standard may comprise an air interface standard such as that of the ACeS system or the Thuraya system, while the CDMA air interface standard may comprise an air interface standard such as that used for the Globalstar™ mobile satellite communications system. The Globalstar™ system is described at http://www.globalstar.com.

The system 800 further includes a ground station 830 including an antenna 832 and a dual interface gateway 834 linked by an RF signal path 831. The dual air interface gateway 834 includes a TDMA air interface circuit 833a that supports the TDMA air interface standard and a CDMA air interface circuit 833b that supports the CDMA air interface standard. TDMA air interface circuit 833a and the CDMA air interface circuit 833b are coupled to a telecommunications switch 835 that provides communications between the TDMA air interface circuit 833a and the CDMA air interface circuit 833b, and between respective ones of the TDMA air interface circuit 833a and the CDMA air interface circuit 833b and one or more external communications networks, such as a PSTN 840 or PLMN 850.

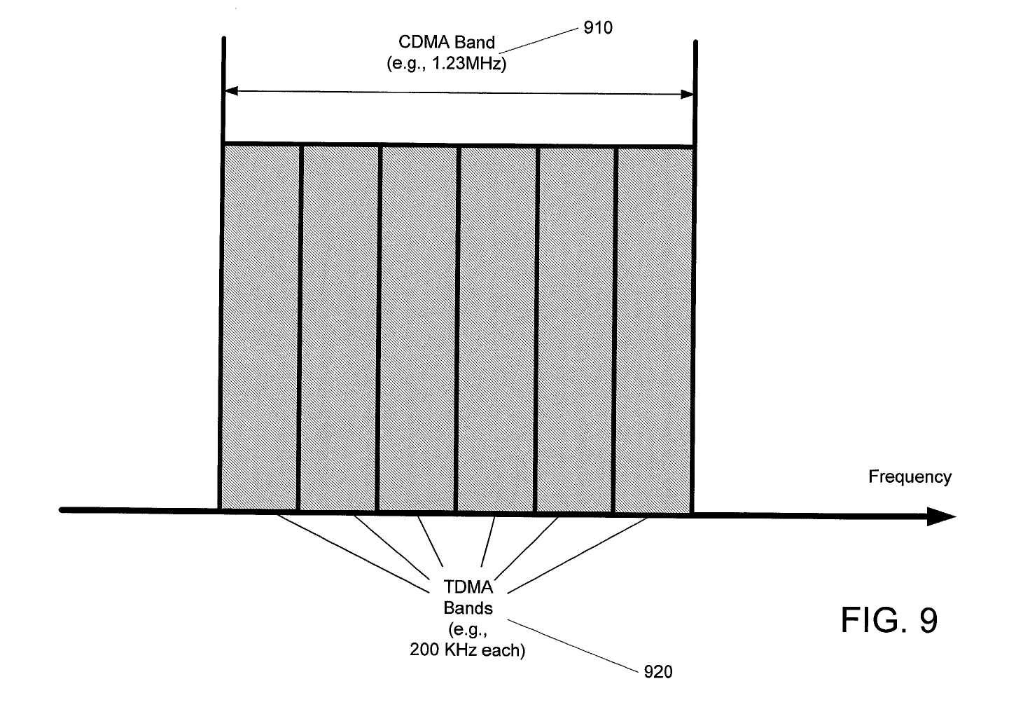

FIG. 9 illustrates how a system, such as the system 800 of FIG. 8, may support both TDMA and CDMA interfaces using a common radio resource. Signals transmitted according to the CDMA air interface standard are spread across a relatively wide frequency band 910 by the action of spreading codes, as is well known to those skilled in the art. TDMA signals transmitted according to the TDMA air interface may use a set of frequency bands 920 within the CDMA band 910.

CDMA waveforms are generally resistant to interference from narrowband sources. For example, if a TDMA carrier is transmitted in the frequency range used by a wideband CDMA signal, the processing gain provided by the spreading/despreading of the CDMA signal may overcome interference arising from the TDMA signal. In turn, the TDMA signal may experience an increase in noise over what might be experienced if the CDMA signal were not present, but this noise may be compensated for by increasing, for example, transmit power and/or error correction coding redundancy. Simulations indicate that capacity loss in the CDMA system due to the presence of the TDMA channels can be equaled or bettered by the increase in capacity provided by the TDMA channels.

For example, as shown in FIG. 9, six contiguous 200 KHz TDMA carrier frequency bands 920 may be fit into a 1.23 MHz wide frequency band 910. Without CDMA signals present and neglecting adjacent channel interference, signal degradation experienced by receivers receiving the TDMA carriers is dominated by thermal noise. Under such conditions, the power level of the TDMA carriers can be adjusted to achieve a desired signal to noise ratio E_{b}/N₀ at the receivers. If a CDMA carrier of this 1.23 MHz bandwidth (which is approximately the bandwidth used in the Globalstar™ system or in IS-95 compliant systems) is overlaid on the TDMA carriers, the noise experienced by the TDMA receivers may be raised from N₀ to N₀+ΔN₀. In order to achieve the same performance as in the non-overlaid environment, the power of each TDMA carrier may be increased by an amount ΔE_{b} in accordance with the relation:

$$\frac{Δ {E}_{b}}{Δ {N}_{0}} = \frac{{E}_{b}}{{N}_{0}} .$$

Although the foregoing discussion of FIGS. 8 and 9 describes used of overlapping CDMA and TDMA carrier frequencies, it will be understood that the present invention is not limited to the used of such overlapping frequencies. For example, a combined CDMA/TDMA gateway/satellite air interface according to other embodiments of the present invention may use non-overlapping TDMA and CDMA carrier frequencies.

It will be further understood that, although gateways, mobile satellite communications systems and methods supporting dual air interface standards are described therein, the present invention encompasses gateways, systems and methods that support more than two air interface standards. In addition, although TDMA/TDMA and TDMA/CDMA systems are described herein, the present invention is also applicable to other combinations of air interfaces.

In the drawings and specification, there have been disclosed typical preferred embodiments of the invention and, although specific terms are employed, they are used in a generic and descriptive sense only and not for purposes of limitation, the scope of the invention being set forth in the following claims.

That which is claimed is:

1. A gateway for a mobile satellite communications system that includes a satellite operative to communicate with mobile terminals, the gateway comprising:
a first air interface circuit operative to communicate with the satellite according to a first air interface standard;
a second air interface circuit operative to communicate with the satellite according to a second air interface standard; and
a telecommunications switch operative to transfer information between the first and second air interface circuits and/or between respective ones of the first and second air interface circuits and an external communications system.

2. A gateway according to claim 1, wherein the first air interface standard comprises a first time division multiple access (TDMA) air interface standard and wherein the second air interface standard comprises a second TDMA air interface standard.

3. A gateway according to claim 1, wherein the first and second air interface circuits communicate with the satellite using non-overlapping frequencies.

4. A gateway according to claim 1, wherein the first and second air interface circuits communicate with the satellite using overlapping frequencies.

5. A gateway according to claim 1, wherein the first air interface standard comprises a TDMA air interface standard and wherein the second air interface standard comprises a code division multiple access (CDMA) air interface standard.

6. A gateway according to claim 5:
wherein the second air interface circuit communicates with the satellite using signals spread over a frequency range; and wherein the first air interface circuit communicates with the satellite using a set of discrete frequency bands in the frequency range.

7. A gateway according to claim 6, wherein the frequency range is approximately 1.23 MHz, and wherein the set of discrete frequency bands comprises six contiguous 200 kHz frequency bands.

8. A gateway according to claim 1, wherein the mobile satellite communications system comprises a first mobile satellite communications system operative to communicate with mobile terminals located in a first coverage area according to the first air interface standard, and wherein a second mobile satellite communications system is operative to communicate with mobile terminals located in a second coverage area according to the second air interface standard.

9. A gateway according to claim 8, wherein the first and second coverage areas neighbor one another.

10. A gateway according to claim 9, wherein the first and second coverage areas do not overlap.

11. A gateway according to claim 8, wherein a first one of the first and second mobile satellite communications systems comprises the Thuraya mobile satellite communications system, and wherein a second one of the first and second mobile satellite communications system comprises the ACeS mobile satellite communications system.

12. A gateway according to claim 1:
wherein the first air interface circuit comprises:
a first channel unit operative to communicate with the satellite on first channels defined according to the first air interface standard and to convey information between the telecommunications switch and the first channels; and
a first channel unit controller operative to control the first channel unit; wherein the second air interface circuit comprises:
a second channel unit operative to communicate with the satellite on second channels defined according to the second air interface standard and to convey information between the telecommunications switch and the second channels; and
a second channel unit controller operative to control the second channel unit.

13. A mobile satellite communications system, comprising a satellite operative to communicate with mobile terminals; and a ground station including:
a first air interface circuit operative to communicate with the satellite according to a first air interface standard;
a second air interface circuit operative to communicate with the satellite according to a second air interface standard.

14. A system according to claim 13, wherein the first and second air interface circuits are included in a gateway that further comprises a telecommunications switch operative to transfer information between the first and second air interface circuits and/or between respective ones of the first and second air interface circuits and an external communications system.

15. A system according to claim 13, wherein the first air interface standard comprises a first time division multiple access (TDMA) air interface standard and wherein the second air interface standard comprises a second TDMA air interface standard.

16. A system according to claim 13, wherein the first and second air interface circuits communicate with the satellite using non-overlapping frequencies.

17. A system according to claim 13, wherein the first and second air interface circuits communicate with the satellite using overlapping frequencies.

18. A system according to claim 13, wherein the first air interface standard comprises a TDMA air interface standard and wherein the second air interface standard comprises a code division multiple access (CDMA) air interface standard.

19. A system according to claim 18:
wherein the second air interface circuit communicates with the satellite using signals spread over a frequency range; and
wherein the first air interface circuit communicates with the satellite using a set of discrete carrier frequencies in the frequency range.

20. A system according to claim 19, wherein the frequency range is approximately 1.23 MHz, and wherein the set of discrete carrier frequencies comprises six carrier frequencies.

21. A system according to claim 12, wherein the at least one satellite is operative to communicate with mobile terminals located in a first coverage area, and wherein a second mobile satellite communications system is operative to communicate with mobile terminals located in a second coverage area according to the second air interface standard.

22. A system according to claim 21, wherein the first and second coverage areas neighbor one another.

23. A system according to claim 22, wherein the first and second coverage areas do not overlap.

24. A system according to claim 21, wherein a first one of the first and second mobile satellite communications systems comprises the Thuraya mobile satellite communications system, and wherein a second one of the first and second mobile satellite communications system comprises the ACeS mobile satellite communications system.

25. A system according to claim 13: wherein the first air interface circuit comprises:
a first channel unit operative to communicate with the satellite on first channels defined according to the first air interface standard and to convey information between the telecommunications switch and the first channels; and
a first channel unit controller operative to control the first channel unit; wherein the second air interface circuit comprises:
a second channel unit operative to communicate with the satellite on second channels defined according to the second air interface standard and to convey information between the telecommunications switch and the second channels; and
a second channel unit controller operative to control the second channel unit.

26. A method of operating a mobile satellite communications system comprising a satellite operative to communicate with mobile terminals over mobile links and to communicate with a ground station over a feeder link, the method comprising:
communicating between the satellite and the ground station over the feeder link according to first and second air interface standards.

27. A method according to claim 26, wherein communicating between the satellite and the ground station comprises:
communicating first information associated with a first mobile terminal over the feeder link according to the first air interface standard; and
communicating second information associated with a second mobile terminal over the feeder link according to the second air interface standard.

28. A method according to claim 26:
wherein communicating between the satellite and the ground station comprises communicating over respective first and second channels defined according to respective ones of the first and second air interface standards; and
where the method further comprises transferring information between the first and second channels or between a respective one of the first and second channels and an external communications system.

29. A method according to claim 26, wherein the first air interface standard comprises a first time division multiple access (TDMA) air interface standard and wherein the second air interface standard comprises a second TDMA air interface standard.

30. A method according to claim 26, wherein the first air interface standard comprises a TDMA air interface standard and wherein the second air interface standard comprises a code division multiple access (CDMA) air interface standard.

31. A method according to claim 26, wherein the mobile satellite communications system comprises a first mobile satellite communications system that is operative to communicate with mobile terminals located in a first coverage area, and wherein a second mobile satellite communications system is operative to communicate with mobile terminals located in a second coverage area according to the second air interface standard.

32. A method according to claim 31, wherein the first and second coverage areas neighbor one another.

33. A method according to claim 32, wherein the first and second coverage areas do not overlap.

34. A method according to claim 31, wherein a first one of the first and second mobile satellite communications systems comprises the Thuraya mobile satellite communications system, and wherein a second one of the first and second mobile satellite communications system comprises the ACeS communications system.
